(19) United States
(12) Patent Application Publication
(10) Pub. No.: US 2005/0264004 A1
(43) Pub. Date: Dec. 1, 2005

(54) Damping device for pipe

(75) Inventors: Mun Sub Kim, Ansan-Si (KR); Jai Kwon Lee, Suwon-Si (KR); Jin Yong Mo, Anyang-Si (KR); Deug Yong Park, Suwon-Si (KR); Hyung Suk Han, Suwon-Si (KR); Ju Hwan Kim, Suwon-Si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/103,488

(22) Filed: Apr. 12, 2005

(30) Foreign Application Priority Data
May 28, 2004 (KR) 2004-38434

(51) Int. Cl. F16L 11/12

(52) U.S. Cl. 285/124.5

(57) ABSTRACT

A pipe damping device including a damping member for reducing vibration of a pipe. The damping member includes a body, a pipe insertion bore formed in the body for the insertion of the pipe, and one or more specimen insertion bores formed in the body, into which one or more specimens, having different masses, are inserted, respectively.

### CROSS-REFERENCE TO RELATED APPLICATION

This application claims the benefit of Korean Patent Application No. 2004-38434, filed on May 28, 2004 in the Korean Intellectual Property Office, the disclosure of which is incorporated herein by reference.

### BACKGROUND OF THE INVENTION

1. Field of the Invention

The present invention relates to a damping device for a pipe, and, more particularly, to a pipe fixing device which is designed to allow a plurality of specimens, having different masses, to be selectively inserted therein, so as to reduce vibration of a pipe.

2. Description of the Related Art

Appliances using cooling devices, such as air conditioners, refrigerators, etc., are often provided with pipes for conducting liquid or gas.

In general, such pipes are mounted inside a casing so that they connect a compressor and a heat exchanger. The pipes also connect solenoid valves, capillary tubes, etc. to each other, which are used to guide a stream of coolant into the compressor and the heat exchanger or adjust a flow rate of the coolant. Since driving of the compressor may give rise to collision between the pipes, and these pipes are welded to various devices, vibration of the pipes can disadvantageously apply an impact to welded portions, resulting in cracks thereat.

As a solution to reduce such vibration of the pipes, a damping member, which is designed to cause a pipe to be inserted into the center of a rubber disk thereof, has been disclosed in the prior art.

However, since such vibration of the pipes caused by the compressor is variable according to operating frequencies of the compressor, and the pipes exhibit a particular vibration property having a directionality, the existing damping member fails to effectively absorb the vibration of the pipes.

Although it has also been proposed to eccentrically form a pipe insertion bore in the disk, this solution still suffers from variation in a vibration property of the pipes if an environment around the pipes is changed compared to an initial installation environment of the damping member, resulting in deterioration in reduction efficiency of vibration. Accordingly, in order to apply another damping member having a different weight, a previously installed damping member must be removed and then the other appropriate damping member must be again installed to the pipe. This results in complicated and overall troublesome installation of the damping member. In addition, it may be a heavy burden to prepare various kinds of plural damping members having different masses.

### SUMMARY OF THE INVENTION

The present invention has been made in view of the above-mentioned problems. An aspect of the invention is to provide a damping device for a pipe, which is designed to allow a plurality of specimens, having different masses, to be selectively inserted therein so as to enable variation in total mass thereof, thereby being capable of reducing vibration of the pipe.

Consistent with one aspect, an exemplary embodiment of the present invention provides a damping device for a pipe comprising a damping member for reducing vibration of the pipe, the damping member comprising: a body; a pipe insertion bore formed in the body, into which the pipe is inserted; and one or more specimen insertion bores formed in the body, into which one or more specimens, having different masses, are inserted, respectively.

A plurality of the specimen insertion bores may have different diameters.

The one or more specimen insertion bores may be internally formed with recessed portions, respectively, and the one or more specimens are externally formed with protruded portions corresponding to the recessed portions of the one or more specimen insertion bores, respectively.

The pipe insertion bore may be eccentrically formed in the body, and the one or more specimen insertion bores may be formed near the pipe insertion bore.

The body may be made of a rubber material, and the specimens may be made of a steel material.

Consistent with another aspect, an exemplary embodiment of the present invention provides a damping device for a pipe comprising: a compressor; a coolant pipe used to conduct a coolant compressed by the compressor; a plurality of specimens having different masses; and a damping member having a pipe insertion bore for the insertion of the coolant pipe, and one or more specimen insertion bores, into which one or more specimens selected from among the plurality of specimens are inserted.

The damping member may be variable in its total mass according to the one or more specimens inserted in the one or more specimen insertion bores.

The damping member may be variable in its mass distribution according to the one or more specimens inserted in the one or more specimen insertion bores.

### BRIEF DESCRIPTION OF THE DRAWINGS

The above aspect, and other features and advantages of the exemplary embodiments of the present invention will become more apparent after reading the following detailed description when taken in conjunction with the drawings, in which:

FIG. 1 is a perspective view illustrating a damping device for a pipe consistent with an exemplary embodiment of the present invention;

FIG. 2 is a sectional view taken along the line A-A shown in FIG. 1; and

FIG. 3 is a partially broken away perspective view illustrating an application wherein the damping device for a pipe consistent with an exemplary embodiment of the present invention is applied to an air conditioner.

### DETAILED DESCRIPTION OF THE EXEMPLARY EMBODIMENTS

An exemplary embodiment of the present invention will now be described in detail with reference to the annexed drawings.

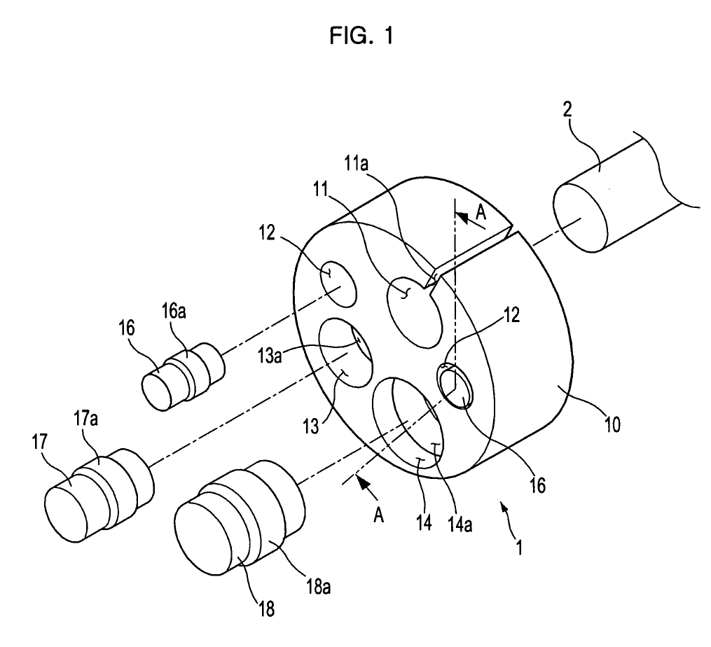

Referring to FIG. 1 illustrating a damping device for a pipe consistent with an exemplary embodiment of the present invention, it comprises a damping member 1 for reducing vibration of a pipe 2. The damping member 1 comprises a disk-shaped rubber body 10, a pipe insertion bore 11 formed in the body 10 for allowing insertion of the pipe 2, and a plurality of specimen insertion bores 12, 13 and 14 formed in the body 10. These specimen insertion bores 12, 13 and 14 have different diameters.

At one side of the pipe insertion bore 11 is formed a slit 11a for securing easy insertion of the pipe 2.

Comparing the plurality of specimen insertion bores, namely, the diameter of a first specimen insertion bore 12 is smaller than the diameter of a second specimen insertion bore 13, and in turn, the diameter of the second specimen insertion bore 13 is smaller than the diameter of a third specimen insertion bore 14.

Into the first to third specimen insertion bores 12 to 14 are selectively inserted first to third specimens 16 to 18, which have different diameters corresponding to the diameters of the first to third specimen insertion bores 12 to 14.

The first to third specimens 16 to 18 are made of a steel material, and have different masses.

Inside the respective specimen insertion bores 12, 13 and 14 are centrally defined recessed portions 12a, 13a and 14a, respectively, in order to prevent the specimens 16, 17 and 18, once inserted in the specimen insertion bores 12, 13 and 14, from being separated therefrom. In correspondence to the recessed portions 12a, 13a and 14a, the respective specimens 16, 17 and 18 are centrally formed at their outer peripheral surfaces with protruded portions 16a, 17a and 18a, respectively.

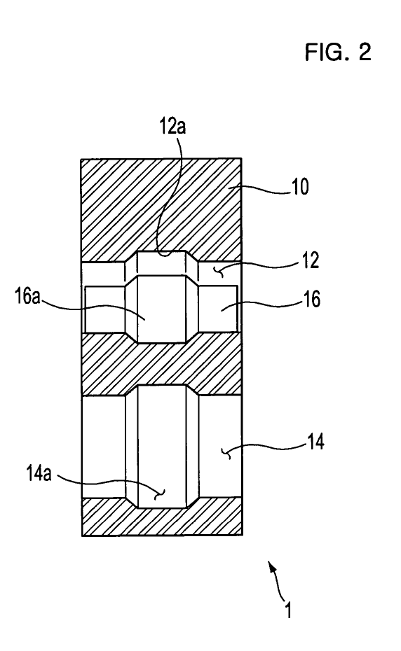

In a state wherein the first specimen 16 is inserted in the first specimen insertion bore 12, as shown in FIG. 2, the protruded portion 16a of the first specimen 16 is seated in the recessed portion 12a of the first specimen insertion bore 12, thereby preventing the first specimen 16 from being easily taken off the specimen insertion bore 12 even when the damping member 1 shakes.

The plurality of specimens 16, 17 and 18 can be selectively used so as to produce various different mass values. Thereby, according to whether one or more specimens are inserted into corresponding specimen insertion bores as desired, the total mass of the damping member 1 is variable. In the present embodiment, for example, the first, second and third specimens 16, 17 and 18 have masses of 10 g, 20 g and 30 g, respectively.

Meanwhile, the pipe insertion bore 11 is eccentrically defined in the body, and the plurality of specimen insertion bores 12, 13 and 14 are arranged near the pipe insertion bore 11. As the specimens 16, 17 and 18 are selectively inserted into the specimen insertion bores 12, 13 and 14, mass distribution of the damping member 1 is variable. Such a variation in mass distribution of the damping member 1 enables a vibration property of the damping member 1 to be varied according to an environment around the pipe if it is changed compared to an initial installation environment of the damping member. This is to allow the mass distribution of the damping member 1 to be determined in consideration of directionality.

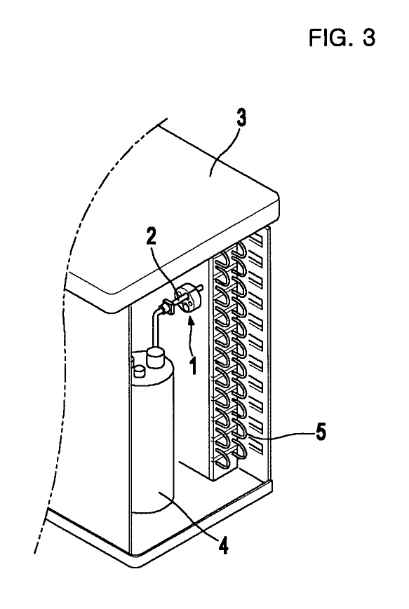

FIG. 3 is a partially broken away perspective view illustrating an application wherein the damping device for a pipe consistent with an exemplary embodiment of the present invention is applied to an air conditioner.

Inside an outdoor unit casing 3 are mounted various driving devices, such as a compressor 4, a heat exchanger 5, etc., and between the compressor 4 and the heat exchanger 5, a plurality of coolant pipes 2 are arranged so as to cross each other. To these coolant pipes 2 are coupled the damping member 1.

Even if vibration is inevitably generated during the operation of the compressor 4, the damping member 1 coupled to the coolant pipe 2 acts to reduce vibration of the pipe 2.

As apparent from the above description, the damping device for a pipe consistent with an exemplary embodiment of the present invention is designed so that a plurality of specimens, having different masses, are selectively inserted into specimen insertion bores defined in a damping member so as to enable variation in the total mass as well as the mass distribution of the damping member, thereby simplifying adjustment operation of the damping member for conforming to a changed vibration property of the pipe. Further, according to an exemplary embodiment of the present invention, even if an environment around the pipe is changed compared to an initial installation environment of the damping member, it is possible to adapt the damping member to conform to a vibration property of the pipe, resulting in good management in reduction of vibration.

Although the exemplary embodiments of the invention have been disclosed for illustrative purposes, those skilled in the art will appreciate that various modifications, additions and substitutions are possible, without departing from the scope and spirit of the invention as disclosed in the accompanying claims.

1. A damping device for a pipe comprising a damping member for reducing vibration of the pipe, the damping member comprising:
a body;
a pipe insertion bore formed in the body, into which the pipe is inserted; and
one or more specimen insertion bores formed in the body, into which one or more specimens, having different masses, are inserted, respectively.

2. The device according to claim 1, wherein a plurality of the specimen insertion bores have different diameters.

3. The device according to claim 1, wherein the one or more specimen insertion bores are internally formed with recessed portions, respectively, and the one or more specimens are externally formed with protruded portions corresponding to the recessed portions of the one or more specimen insertion bores, respectively.

4. The device according to claim 1, wherein the pipe insertion bore is eccentrically formed in the body, and the one or more specimen insertion bores are formed near the pipe insertion bore.

5. The device according to claim 1, wherein the body is made of a rubber material, and the specimens are made of a steel material.

6. A damping device for a pipe comprising:
a compressor;
a coolant pipe used to conduct a coolant compressed by the compressor;
a plurality of specimens having different masses; and
a damping member having a pipe insertion bore for the insertion of the coolant pipe, and one or more specimen insertion bores, into which one or more specimens selected from among the plurality of specimens are inserted.

7. The device according to claim 6, wherein the damping member is variable in its total mass according to the one or more specimens inserted in the one or more specimen insertion bores.

8. The device according to claim 6, wherein the damping member is variable in its mass distribution according to the one or more specimens inserted in the one or more specimen insertion bores.
